(19) United States
(12) Patent Application Publication
(10) Pub. No.: US 2003/0104786 A1
(43) Pub. Date: Jun. 5, 2003

(54) System and method for allocation of substreams in circuit switched connections

(76) Inventors: Stefan Wilhelm Jung, Brottby (SE); Peter Hans Edlund, Tumba (SE); Lars-Goran Lund, Bromma (SE); Erik Andreas Colban, Oslo (NO); Christer Edholm, Stockholm (SE); Patrik Bredin, Huddinge (SE)

Correspondence Address: Spencer C. Patterson, Jenkens & Gilchrist, A Professional Corporation, 1445 Ross Avenue, Suite 3200, Dallas, TX, 75202, US

(21) Appl. No.: 09/994,332

(22) Filed: Nov. 26, 2001

(51) Int. Cl. H04B 17/00

(52) U.S. Cl. 455/67.1

(57) ABSTRACT

In a system and method of adapting an ECSD connection, interruption times and data loss due to a change in the modulation, coding scheme, and number of timeslots of the connection may be minimized or eliminated. The interruption times and data loss may be minimized or eliminated by allocating a peak number of substreams for a given mobile radio connection based on a user requested data rate and/or the number of timeslots used to realize the user requested data rate. Data loss may also be minimized or eliminated by using in-band signaling to signal a change in the modulation, coding scheme, and/or number of timeslots.

### BACKGROUND

1. Technical Field of the Invention

The present invention relates to mobile communication systems and, in particular, to a method and system for allocation of substreams in circuit switched connections.

2. Description of the Related Art

Achieving higher data rates continues to be an objective of mobile communication system developers. For example, the first generation of circuit switched (CS), time division multiple access (TDMA) systems, such as the Global System for Mobile communication (GSM), were capable of transporting data at a maximum data rate of only 9.6 kbps. These systems typically allocate a single radio frequency timeslot for each mobile radio connection. The introduction of high speed circuit switched data (HSCSD) systems allowed multiple radio frequency timeslots to be allocated to a single mobile radio connection, thereby achieving data rates of up to 64 kbps. With the development of enhanced circuit switched data (ECSD) systems, data rates similar to HSCSD systems may be achieved, but with fewer radio frequency timeslots by using improved modulation and coding schemes.

ECSD systems use 8-PSK modulation, which makes it possible to employ 28.8 kbps, 32.0 kbps, and 43.2 kbps coding schemes over the radio interface. Thus, data rates of up to 43.2 kbps per single radio frequency timeslot and 64 kbps for multiple (e.g., two) radio timeslots may be achieved. The modulation and coding scheme used, and sometimes the number of radio frequency timeslots allocated, are constrained by the quality of the radio conditions. For example, in excellent radio conditions, a 43.2 kbps modulation and coding scheme may be used, whereas in good radio conditions, a 28.8 kbps modulation and coding scheme may be used, and in bad radio conditions, a 14.4 kbps modulation and coding scheme may be used.

In order to select the optimal modulation and coding scheme in changing radio conditions, and also to ensure robust data transmission, a Link Quality Control (LQC) function is implemented in ECSD systems. The LQC uses quality measurement reports received from mobile stations and base stations to determine the current radio conditions, and adjusts the modulation and coding scheme accordingly. The specific adjustment made by the LQC depends on whether the connection is a transparent (T) or non-transparent (NT) connection. In general, a transparent connection is one wherein errors occurring during the transmission are corrected through the use of encoding techniques. Connections that are non-transparent, on the other hand, rely on retransmission in addition to encoding techniques to compensate for errors.

For such non-transparent connections, the LQC may change the modulation and coding scheme used on the radio frequency timeslot, and sometimes also the number of radio frequency timeslots, in order to adapt the connection to changing radio conditions. If the number of radio frequency timeslots used is not changed (i.e., kept constant), a modulation and coding scheme adjustment may cause the user to experience noticeable variations in data throughput. In contrast, for a transparent connection, the LQC preserves the data throughput by changing the number of radio frequency timeslots used as well as the modulation and coding schemes. The number of radio frequency timeslots may be changed, for example, in GSM using the standard Timeslot Adaptation (TSA) procedure wherein certain radio frequency timeslots are activated while other timeslots are released.

FIG. 1 shows an implementation of the LQC in a pertinent portion of an exemplary mobile communication system 100. As can be seen, the LQC 102 may be implemented as a functional component or module in a base station controller (BSC) 104. The BSC 104 is connected to one or more base transceiver stations (BTS) 106 across a standard interface known as an Abis interface, and controls such functions as handovers and channel assignments for the BTS. Each BTS is connected to and controls one or more mobile stations (MS) 108 via a radio frequency link across a radio interface. The BTS and the BSC together form what is generally referred to as a base station subsystem (BSS) 110. A mobile services switching center (MSC) 112 is connected to one or more BSS across a standard interface known as an A interface. The MSC controls the routing of calls between the mobile communication system 100 and other telephony and data communication systems, shown here generally at 114. Such other telephony and data communication systems may include the public switched telephone network (PSTN), integrated services digital network (ISDN), public land mobile network (PLMN), circuit switched public data network (CSPDN), packet switched public data network (PSPDN), and various other networks.

Because the various telephony and data networks are different from one another, a communications module called an interworking function (IWF) 116 is implemented in the MSC to enable data transmission and protocol adaptation from one network to another. In addition, a module known as a transcoder and rate adapter unit (TRAU) 118 is implemented in the BSC to synchronize the data transfer across the A interface with the data transfer across the Abis interface. As a result, the IWF can send and receive data over the Abis interface that will be synchronized to the BTS. Similarly, a TRAU 120 in the BTS allows it to send and receive data over the A interface that will be synchronized to the IWF. The TRAU in the BSC and BTS are labeled A-TRAU and E-TRAU, respectively.

Operation of the system 100 will now be described in general terms. For each ECSD connection, the MSC/IWF allocates one PCM (pulse code modulation) timeslot that is capable of carrying a 64 kbps stream of data over the A interface. Downlink data being sent from the MSC/IWF is then mapped onto a certain number of 16 kbps substreams that usually, or by default, include 14.4 kbps of data and 1.6 kbps of control bits. The substreams are multiplexed on the 64 kbps PCM timeslot and sent over the A interface to the BSC. The BSC receives the substreams and subsequently forwards them over the Abis interface to the BTS. The BTS encodes the substreams and sends them over the radio interface to the MS. On the uplink, data is sent on a certain number of radio frequency timeslots from the MS over the radio interface to the BTS. The BTS decodes the radio frequency timeslot and maps the data on to substreams which are forwarded over the Abis interface to the BSC. The BSC multiplexes the substreams on the PCM timeslot and sends them over the A interface to the MSC/IWF. The substreams are subsequently demultiplexed from the PCM timeslot and forwarded to the other communication systems 114.

Presently, the maximum number of substreams that may be used for one connection is four. The number of substreams actually allocated at call setup, however, depends on the requested user rate, or WAIUR. Any substream that is not assigned will be used to carry idle data. When a connection is initiated (either by the MS or by the other communication systems 114), the LQC looks at the WAIUR and determines an appropriate modulation and coding scheme. Based on the WAUIR and the modulation and coding scheme, the LQC allocates a certain number of substreams for the connection. For example, the LQC may allocate three substreams to a connection having a WAUIR of 43.2 kbps where the radio conditions allow such a modulation and coding scheme.

The allocated number of substreams that will be used for the connection have to be set up on the A and the Abis interfaces. More specifically, the A-TRAU and E-TRAU sub-circuits of the BSC and the BTS, respectively, have to be set up to synchronize and otherwise process the allocated number of substreams. Thus, for the connection in the example above, the A-TRAU and the E-TRAU of the BSC and the BTS, respectively, have to be set up to synchronize data from three substreams.

At the MSC/IWF, a whole 64 kbps PCM timeslot will be used to carry the allocated number of substreams. Thus, the MSC/IWF simply needs to be notified of the number of substreams to be used.

On the radio interface between the BTS and the MS, up to n radio frequency timeslots may be assigned by the LQC to serve n substreams. For example, up to three radio frequency timeslots may be assigned by the LQC to serve a WAIUR of 43.2 kbs which will require three substreams. The particular number of radio frequency timeslots assigned depends on the number of available timeslots and the radio condition and WAIUR. For example, a WAIUR of 43.2 kbps would, in good radio conditions, correspond to a modulation and coding scheme of 43.2 kbps on the radio interface, which allows for three substreams of data (without control bits) to be carried on one radio frequency timeslot. In that case, the LQC only needs to assign one radio frequency timeslot to the connection.

When the quality of the radio condition changes, the LQC may change the modulation and coding scheme (and sometimes also the number of radio frequency timeslots) accordingly. However, changing the modulation and coding scheme of the radio interface involves a change in the number of substreams allocated per radio frequency timeslot. Such a change, in turn, impacts the number of substreams being used for transferring data across the A and Abis interfaces. More specifically, changing the modulation and coding schemes involves setting up and releasing one or more substreams in the 16 kbps sub-circuits of the A-TRAU and the E-TRAU modules.

On the A interface, a substream is available for data transfer only after A-TRAU synchronization is completed for that substream. Synchronization includes the reception of at least one A-TRAU frame before the new substream is available for data transfer. Thus, significant interruption time in the flow of data can occur when the modulation and coding scheme is changed. Upgrading an ongoing connection (e.g., increasing the data rate), for example, can result in interruption times on the order of 20-620 milliseconds, which correspond to 1-27 kilobits of data. For a mobile radio connection that is already at the maximum data rate, switching the coding scheme can result in temporary data rate reductions of 2-43.2 kbps.

On the Abis interface, the substreams are dynamically allocated to the E-TRAU sub-circuits, and synchronization is performed via E-TRAU frame detection. Thus, the interruption times due to changes in the modulation and coding scheme are about the same as on the A interface.

In addition to data flow interruption times, changes in the modulation, coding scheme, and number of radio frequency timeslots may also result in data being lost due to the way the BSC/LQC informs or signals the MS, BTS, and MSC/IWF of the changes. For GSM circuit switched data services, including ECSD, existing procedures such as the Intra-cell Handover procedure, the Channel Mode Modify procedure, and/or the Assignment Command procedure may be used. Depending on the type of change being implemented, a different signaling procedure may be used.

FIG. 2 illustrates the Channel Mode Modify procedure used for both single radio frequency timeslot and multiple timeslot configurations to change the coding scheme (but not the number of radio frequency timeslots). At 201, the MS sends measurements of the radio environment to the BTS, including signal strength measurements, C/I ratio (carrier-to-interference), bit error rate, and the like, on the slow associated control channel (SACCH). The measurements are typically sent once every 480 milliseconds. Thus, in general, any change in the modulation, coding scheme, and number of radio frequency timeslots cannot occur more frequently than every 480 milliseconds. At 202, the BTS receives the measurements and forwards a report with these measurements together with its own measurements to the BSC/LQC. From the measurement result, the BSC/LQC can determine whether a change in the coding scheme (hence, a change in the allocated substreams) is wanted. Such a change may be wanted, for example, to improve the robustness of the data transmission across the radio interface. Upon determining that a change is wanted, the BSC/LQC sends a Mode Modify message to the BTS at 203, including information regarding the new coding scheme.

The BSC/LQC then notifies the MSC/IWF that a change in the coding scheme has taken place by sending a Handover (HO) Performed message at 204 to the MSC. The MSC/IWF thereafter switches (not expressly shown) to the new coding scheme (i.e., starts using the reallocated substreams) and begins sending data according to the new coding scheme. In the meantime, at 205, the BSC/LQC sends a Channel Mode Modify message to the MS that includes information regarding the new coding scheme. At 206, the BTS switches to the new coding scheme and sends a Mode Modify Acknowledgment message to the BSC/LQC to confirm that the Mode Modify message has been executed. Likewise, at 207, the MS switches to the new coding scheme and sends a Channel Mode Modify Acknowledgment message to the BSC/LQC to confirm that the Channel Mode Modify message has been executed.

From the foregoing, it can be seen that during the period of switching to the new coding scheme, there may be a mismatch between the coding schemes used by the MS and the BTS, which may result in a loss of data. Specifically, data may be lost if one node sends data toward the other node formatted for a coding scheme other than what is expected by the other node. For example, due to the signaling sequence, there may be an interval where the BTS starts using the new coding scheme to decode data from the MS before data encoded with the new coding scheme has been received. Thus, the data transmitted from the MS to the BTS during this interval will be incorrectly decoded. A similar error may result on the data transmission from the BTS to the MS.

Accordingly, it is desirable to be able to provide a system and method of adapting an ECSD connection wherein data flow interruption times and data loss associated with adjusting the modulation, coding scheme, and number of timeslots of the connection may be minimized or eliminated.

### SUMMARY OF THE INVENTION

The present invention is directed to a system and method of adapting an ECSD connection wherein interruption times and data loss due to a change in the modulation, coding scheme, and/or number of timeslots of the connection may be minimized or eliminated. The interruption times and data loss may be minimized or eliminated by allocating a peak number of substreams for a given mobile radio connection based on a user requested data rate and/or the number of timeslots used to realize the user requested data rate. Data loss may also be minimized or eliminated by using in-band signaling to signal a change in the modulation, coding scheme, and/or number of timeslots.

In general, in one aspect, the invention is directed to a method of optimizing data throughput in a circuit switched mobile radio connection. The method comprises determining a peak number of substreams that may be used for the mobile radio connection, and allocating the determined peak number of substreams to be used for the mobile radio connection. The peak number of substreams may be determined based on a user requested data rate and/or a number of radio frequency timeslots used to realize the requested user data rate. Allocation of the peak number of substreams may be made on a per timeslot basis, or on a per connection basis. A quality of the radio frequency interface is monitored, and the mobile radio connection is adjusted to carry user data on fewer substreams than the peak number of substreams if the quality of the radio frequency interface is below a predefined level. Substreams that were allocated, but that are not carrying user data are as a result of the adjustment, are still retained as part of the connection.

In general, in another aspect, the invention is directed to a mobile communication system capable of supporting a circuit switched mobile radio connection. The system comprises a base transceiver station, a mobile services switching center, and a base station controller connected to the base transceiver station and the mobile services switching center. The base station controller is configured to determine a peak number of substreams that may be used for the mobile radio connection, and to allocate the determined peak number of substreams to be used for the mobile radio connection. The peak number of substreams may be determined based on a user requested data rate and/or a number of radio frequency timeslots used to realize the requested user data rate. Allocation of the peak number of substreams may be made on a per timeslot basis, or on a per connection basis. A quality of the radio frequency interface is monitored, and the mobile radio connection is adjusted to carry user data on fewer substreams than the peak number of substreams if the quality of the radio frequency interface is below a predefined level. Substreams that were allocated, but that are not carrying user data are as a result of the adjustment, are still retained as part of the connection.

In general, in yet another aspect, the invention is directed to method of signaling a change in an ECSD connection. The method comprises the steps of using a standard signaling procedure to signal the change, sending information regarding the change on one or more downlink traffic channels in the standard signaling procedure, and delaying issuance of a handover signal in the standard signaling procedure until after reception of the change has been acknowledged.

In general, in still another aspect, the invention is directed to an ECSD mobile radio system. The system comprises a base transceiver station, a mobile services switching center, and a base station controller connected to the base transceiver station and the mobile services switching center. The base station controller configured to use a standard signaling procedure to signal a change in a mobile radio connection, send information regarding the change on one or more downlink traffic channels in the standard signaling procedure, and delay issuance of a handover signal in the standard signaling procedure until after reception of the change has been acknowledged.

### BRIEF DESCRIPTION OF THE DRAWINGS

A more complete understanding of the present invention may be had by reference to the following detailed description when taken in conjunction with the accompanying drawings, wherein:

FIG. 1 illustrates a pertinent portion of a typical mobile communication system;

FIG. 2 illustrates a timing diagram for a standard signaling procedure;

FIG. 3 illustrates a base station controller according to some embodiments to the invention;

FIG. 4 illustrates a data format for in-band signaling according to some embodiments of the invention;

FIG. 5 illustrates a timing diagram for an in-band signaling procedure according to some embodiments of the invention;

FIG. 6 illustrates another timing diagram for an in-band signaling procedure according to some embodiments of the invention;

FIG. 7 illustrates another timing diagram for an in-band signaling procedure according to some embodiments of the invention;

FIG. 8 illustrates still another timing diagram for an in-band signaling procedure according to some embodiments of the invention;

FIG. 9 illustrates yet another timing diagram for an in-band signaling procedure according to some embodiments of the invention;

FIG. 10 illustrates a method of optimizing data throughput in a circuit switched mobile radio connection according to some embodiments of the invention.

### DETAILED DESCRIPTION OF THE DRAWINGS

Following is a detailed description of the drawings wherein reference numerals for like and similar elements are carried forward.

Embodiments of the invention provide a system and method of adapting a mobile radio connection wherein interruption times and data loss associated with adjusting the modulation, coding scheme, and/or number of radio frequency timeslots may be minimized or eliminated. A substream allocation algorithm determines a peak number of substreams that may be used for the mobile radio connection. The substream allocation algorithm may determine the peak number of substreams based on a user requested data rate and/or a number of radio frequency timeslots used to realize the requested user data rate. The determined peak number of substreams is thereafter allocated to the mobile radio connection on a per radio frequency timeslot basis, or on a per connection basis. The radio interface is monitored, and if the quality thereof falls below a predefined level, the mobile radio connection is adjusted to carry user data on fewer than the peak number of substreams. Substreams that were allocated, but that are no longer carrying user data are as a result of the adjustment, are still retained as part of the connection. In addition, or alternatively, a signaling procedure may be used to signal changes in the modulation, coding scheme, and/or number of radio frequency timeslots.

Peak allocation involves allocating the highest number of substreams needed over the A interface and the Abis interface on a per radio frequency timeslot basis or on a per connection basis for a given mobile radio connection. As mentioned earlier, the peak number of substreams may be determined based on the requested user data rate and/or the number of radio frequency timeslots used to realize the requested user data rate. Under this arrangement, every substream that may be needed by the mobile radio connection to satisfy the user requested data rate will already be allocated (i.e., no new substreams need to be set up). Such peak allocation may result in some substreams becoming idle when the radio interface deteriorates and the modulation and coding scheme have to be changed to ensure adequate robustness of the data transmission. However, such over-provisioning of substreams eliminates the need to set up new substreams in the BSC/LQC and BTS when higher data rates become supportable again in the radio interface. More specifically, such over-provisioning minimizes or eliminates the interruption times related to A-TRAU and E-TRAU frame synchronization (described above) when a change in the modulation, coding scheme, and/or number of radio frequency timeslots takes place.

In some embodiments, the MSC/IWF continuously detects used and unused substreams on the uplink and maintains the peak allocated number of substreams regardless of any change in the radio interface. If a change in the user data rate results in a used substream becoming idle or vice versa, the BCS/LQC performs out-band signaling using, for example, the Channel Mode Modify procedure to notify the BTS and the MSC/IWF of the number of used and unused substreams to read from the uplink.

Any change in the coding scheme and modulation by the BSC/LQC impacts the number of substreams needed both for single and multiple radio frequency timeslot configurations. However, instead of being released, a substream that becomes unused in the uplink direction is retained and will carry idle data generated by the BTS that are sent as idle E-TRAU frames. The idle E-TRAU frames are forwarded to the MSC/IWF by the BSC/LQC as idle A-TRAU frames. Similarly, unused substreams in the downlink direction are retained and will carry idle A-TRAU frames generated by the MSC/IWF, which idle frames will be received as idle E-TRAU frames by the BTS.

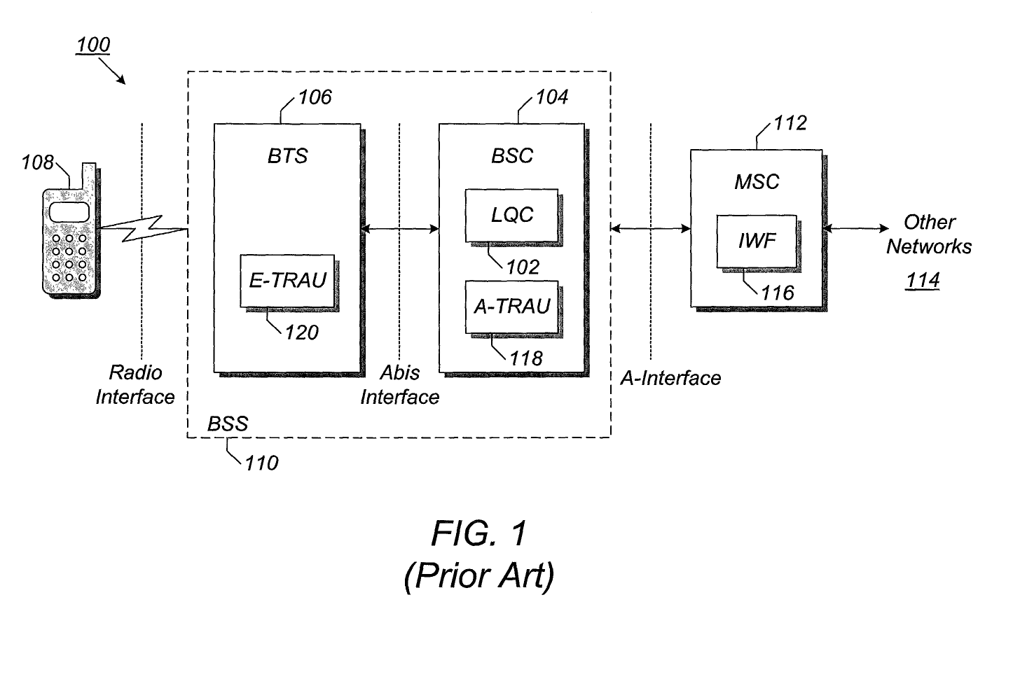

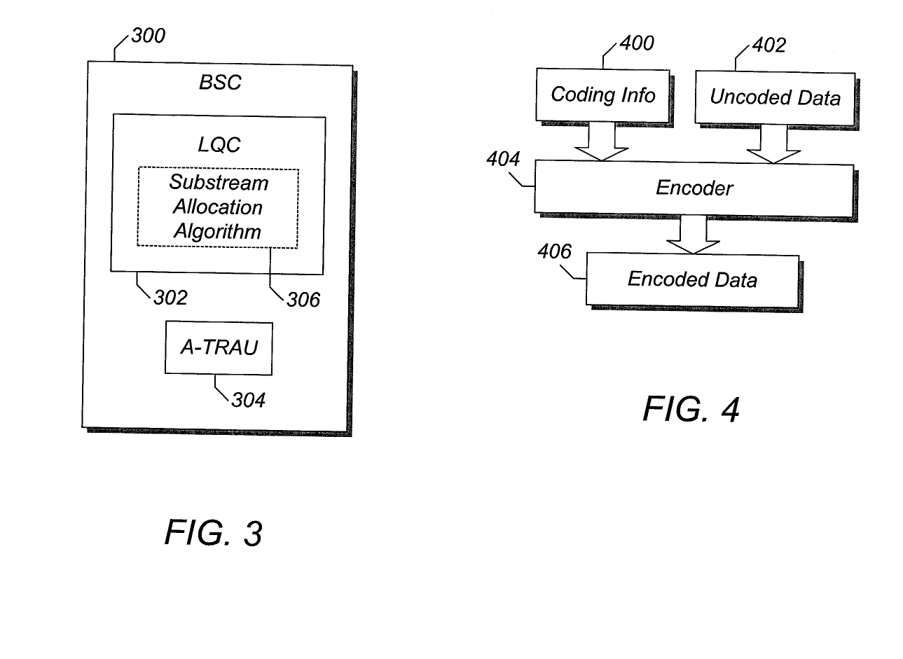

Referring now to FIG. 3, a BSC 300 according to some embodiments of the invention is shown. The BSC 300 includes an LQC 302 and an A-TRAU 304, both of which are configured to perform similar functions as their counterparts in FIG. 1. In addition, the LQC 302 includes a substream allocation algorithm 306 that is capable of determining a peak number of substreams for a given mobile radio connection.

In some embodiments, the substream allocation algorithm 306 is configured to determine the peak number of substreams needed for a mobile radio connection. In these embodiments, the peak number of substreams may be based on the number of radio frequency timeslots to be used alone, or together with the requested user data rate or WAIUR. Where the allocation of substreams is based only on the number of radio frequency timeslots used, the substream allocation algorithm 306 may maximize the allocation of substreams, as shown in TABLE 1.

TABLE 1

| | Substreams per | Substreams per |
|---|---|---|
| Timeslots | Timeslots | Connection |
| 4 | 1 | 4 |
| 3 | 1 | 3 |
| 2 | 2 | 4 |
| 1 | 3 | 3 |

As can be seen, where there are four or three radio frequency timeslots available to be used for one connection, a maximum of one substream will be allocated to each timeslot. Alternatively, a peak of four and three substreams may be allocated, respectively, on a per connection basis. Note that four radio frequency timeslots is the highest number of timeslots that may be assigned for one connection in present circuit switched systems, including ECSD systems. The four and three radio frequency timeslots will then be used to achieve a maximum data rate of 57.6 kbps and 43.2 kbps, respectively. Since only one substream will be carried on each radio frequency timeslot, the modulation and coding scheme used over the radio interface is 14.4 kbps. Under this arrangement, it may be that sometimes more substreams are allocated than necessary, especially where the radio interface is capable of supporting higher modulation and coding schemes.

Where only two radio frequency timeslots are available to be used, a peak of two substreams may be allocated per timeslot or four substreams for the connection. The modulation and coding scheme used over the radio interface is then 28.8 kbps, implying good radio conditions. Should the radio conditions deteriorate, the LQC may need to change the modulation and coding scheme to 14.4 kbps. In that case, only one substream per radio frequency timeslot will carry data while the other one carries idle data. Nevertheless, all allocated substreams are retained as part of the connection and are ready to be used again should radio conditions improve. Accordingly, no substreams will need to be set up or released.

Similarly, where only one radio frequency timeslot is available to be used for a connection, a peak of three substreams may be allocated thereto. The modulation and coding scheme used is 43.2 kbps, as all three substreams may be multiplexed on one radio frequency timeslot. All three substreams will be retained should the modulation and coding scheme need to be changed to reflect deteriorating radio conditions. The retained substreams are thus ready to be used again once radio conditions improve.

In some embodiments, the peak allocation of substreams is determined based on both the user requested data rate (WAIUR) and the number of radio frequency timeslots in order to avoid allocating more substreams than is otherwise necessary. In these embodiments, the substream allocation algorithm 306 may determine the peak allocations to satisfy the requested user rate, as shown in TABLE 2.

TABLE 2

| | | Substreams per | Substreams per |
|---|---|---|---|
| WAIUR | Timeslots | Timeslot | Connection |
| 57.6 kbps | 2 | 2 | 4 |
| 28.8 kbps | 2 | 1 | 2 |
| 43.2 kbps | 1 | 3 | 3 |
| 14.4 kbps | 1 | 1 | 1 |

As can be seen, where the connection has a requested user rate of 57.6 kbps, but only two radio frequency timeslots are available, a peak of two substreams may be allocated per timeslot, or four substreams for the connection. Where two radio frequency timeslots are available, but the requested user rate is only 28.8 kbps, a peak of one substream will be allocated per timeslot, or two substreams for the connection.

Where the requested user rate is 43.2 kbps, but only one radio frequency timeslot is available to be used, a peak of three substreams will be allocated to the timeslot (hence, to the connection). The modulation and coding scheme may thereafter be changed as needed to reflect changing radio conditions, but the three substreams will be retained for the duration of the connection. Similarly, where only one radio frequency timeslot is available to used, but the requested user rate is only 14.4 kbps, a peak of one substream will be allocated to the timeslot.

To take a specific example, applying the substream allocation algorithm 306 to a mobile radio connection having a user requested data rate (WAIUR) of 43.2 kbps and one radio frequency timeslot to be used results in the substream usage shown in TABLE 3.

TABLE 3

| Radio | | Used | Idle | Total |
|---|---|---|---|---|
| Conditions | Data Rate | Substreams | Substreams | Substreams |
| Excellent | 43.3 kbps | 3 | 0 | 3 |
| Good | 28.8 kbps | 2 | 1 | 3 |
| Bad | 14.4 kbps | 1 | 2 | 3 |

As can be seen from the foregoing, the total number of allocated substreams remains the same even under varying radio conditions. Consequently, the need to switch or change the allocation of substreams may be reduced or even eliminated, and few or no interruptions are incurred due to A-TRAU and E-TRAU frame synchronization. Such a result may be achieved because, as noted earlier, no new substreams are needed beyond the number of substreams that is initially allocated for the mobile radio connection. The substream allocation algorithm 306 may also be applied on a per connection basis for applications requiring more than one mobile radio connection (e.g., multimedia applications). Moreover, loss of data due to mismatches in the modulation and coding scheme used may be minimized or eliminated by virtue of having to perform fewer or no signaling procedures.

In some embodiments, mismatches in the modulation and coding scheme employed for the uplink and downlink may also be avoided by adding the coding scheme information directly to the encoded data in the traffic channel on a per radio block basis. Thus, all affected nodes are informed of the proper modulation and coding scheme to be used at the time that the data is received. It should be noted that this type of in-band signaling procedure is a separate and different approach than the peak substream allocation approach. Nevertheless, in some embodiments, the in-band signaling procedure can be used in conjunction with the peak substream allocation approach to further minimize or eliminate data loss due to changes in the modulation and coding scheme. Alternatively, in some embodiments, the in-band signaling procedure may be used instead of the peak substream allocation approach.

Referring now to FIG. 4, in in-band signaling, extra bits 400 representing the modulation and coding scheme are encoded directly with the data 402 to be transferred. The encoding is performed by an encoder 404, the output from which is an encoded radio block 406. Thus, the radio block 406 now includes the modulation and coding scheme information that can be used to process the data. In some embodiments, the extra bit are signaling bits representing the modulation and coding scheme. Presently, it is contemplated that traffic channel data rates of 64 kbps and 32 kbps will not use in-band signaling as only one coding scheme is employed for these transparent service data rates.

In general, there are two ways of performing in-band signaling: partial in-band signaling, and full in-band signaling. Partial in-band signaling involves sending the coding scheme information for both the uplink and downlink within the data traffic channel. Full in-band signaling involves sending the radio quality measurement reports as well as the coding scheme information for both the uplink and downlink within the traffic channel. It is also possible that different coding schemes may be applied in the uplink versus the downlink using either type of in-band signaling procedures.

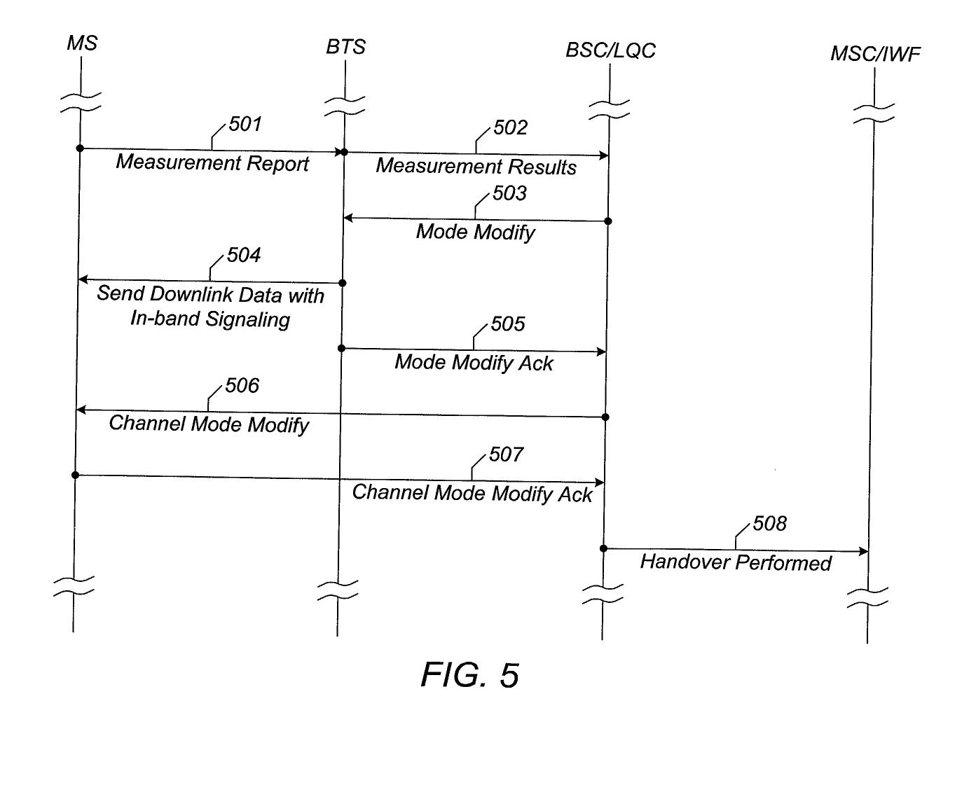

FIGS. 5-8 illustrate exemplary embodiments of the present invention wherein partial in-band signaling is used. In these figures, the timing and content of several standard signals have been changed to reflect improvements and enhancements made according to some embodiments of the invention. It is contemplated that some reconfiguration of the BTS, BSC/LQC, and the MSC/IWF will need to be effected in order to accommodate the changes in the timing and content of the various signals. Such reconfiguration, however, are believed to be well within the knowledge and skill of those versed in the wireless telecommunications art.

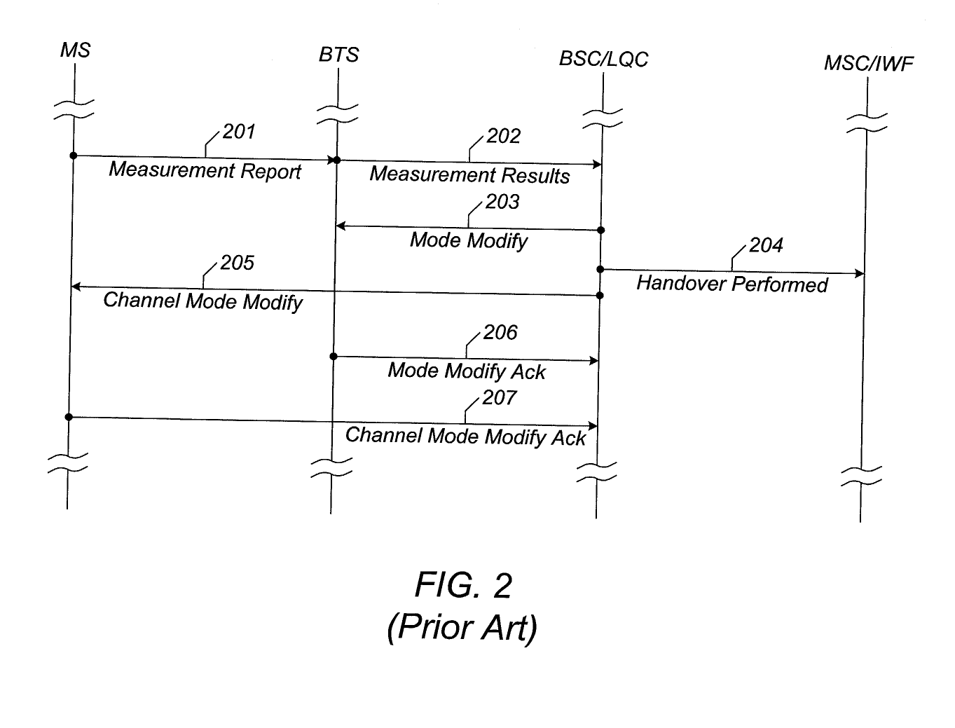

Referring now to FIG. 5, an exemplary partial in-band signaling procedure based on the standard Channel Mode Modify procedure in FIG. 2 is shown according to some embodiments of the invention. The partial in-band signaling procedure in FIG. 5 differs from the Channel Mode Modify procedure in FIG. 2 in that the modulation and coding scheme used on the downlink is now included with the data sent in the traffic channel, as shown at 504. Also, the Handover Performed signal has been pushed back in time to after the Channel Mode Modify Ack signal has been received by the BSC.

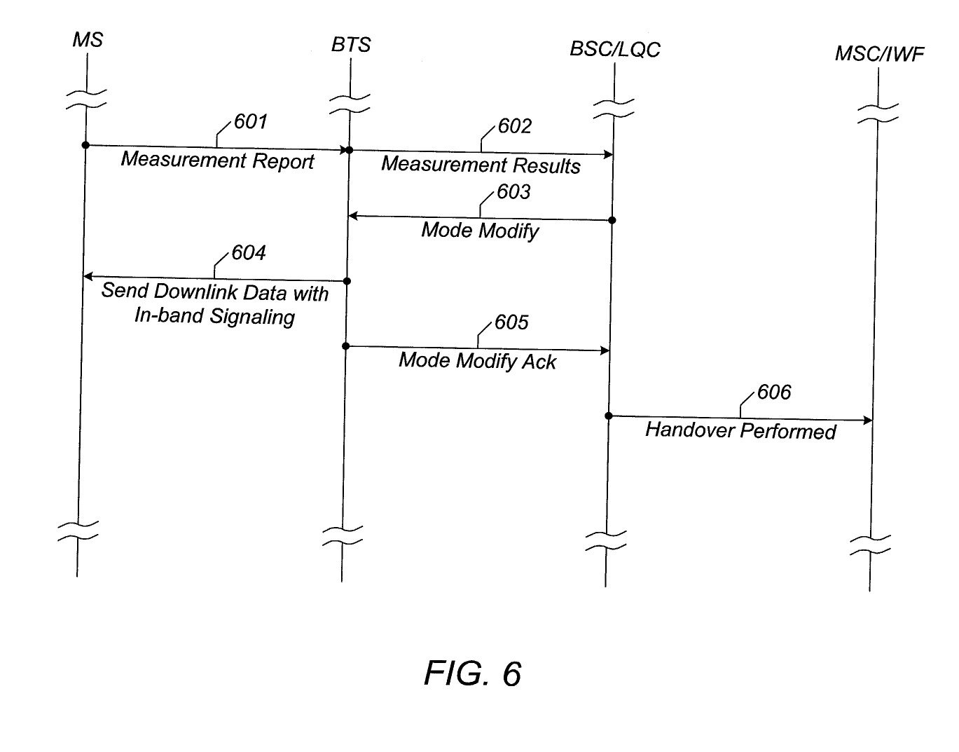

FIG. 6 illustrates another exemplary partial in-band signaling procedure according to some embodiments of the invention. The partial in-band signaling procedure in FIG. 6 differs from the procedure in FIG. 5 in that two out-band signals, Channel Mode Modify and Channel Mode Modify Ack, have been removed, thus eliminating about 250 milliseconds of delay associated with these two signals.

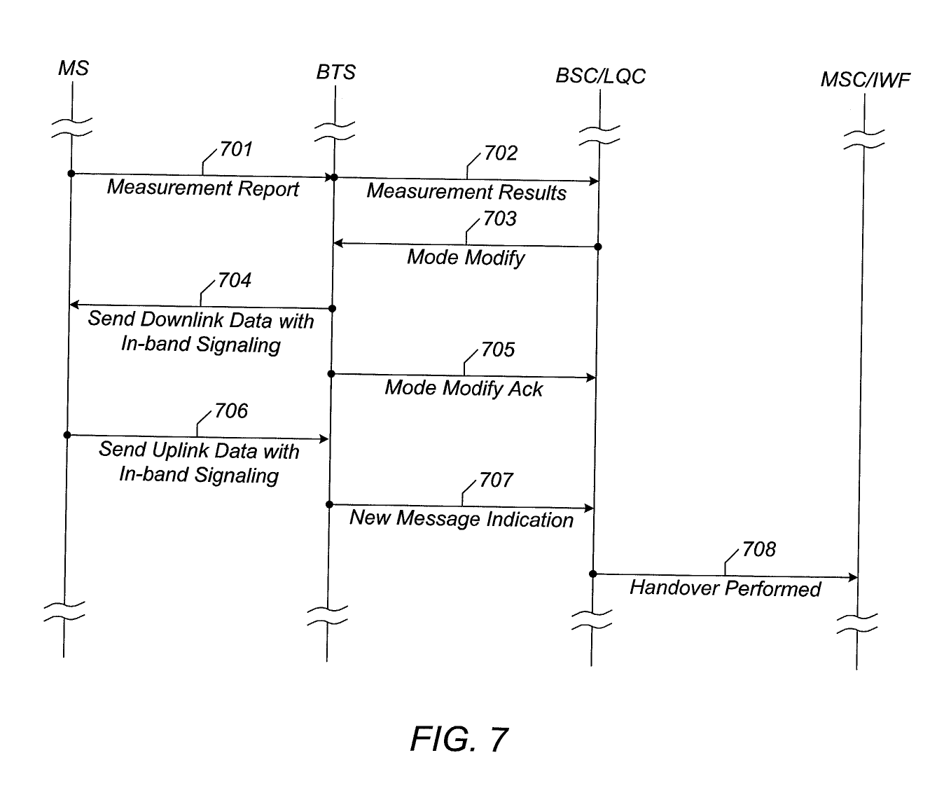

FIG. 7 illustrates still another exemplary partial in-band signaling procedure according to some embodiments of the invention. The procedure shown in FIG. 7 differs from the procedure shown in FIG. 6 in that in-band signaling is also performed on the uplink at 706. In this procedure, the Handover Performed signal is sent from the BSC/LQC to the MSC/IWF at 708 only when the BSC/LQC has received a New Message indication from the BTS. The BTS sends the New Message indication signal at 707 only when it has received confirmation of a change to the new modulation and coding scheme by the MS via in-band signaling at 806.

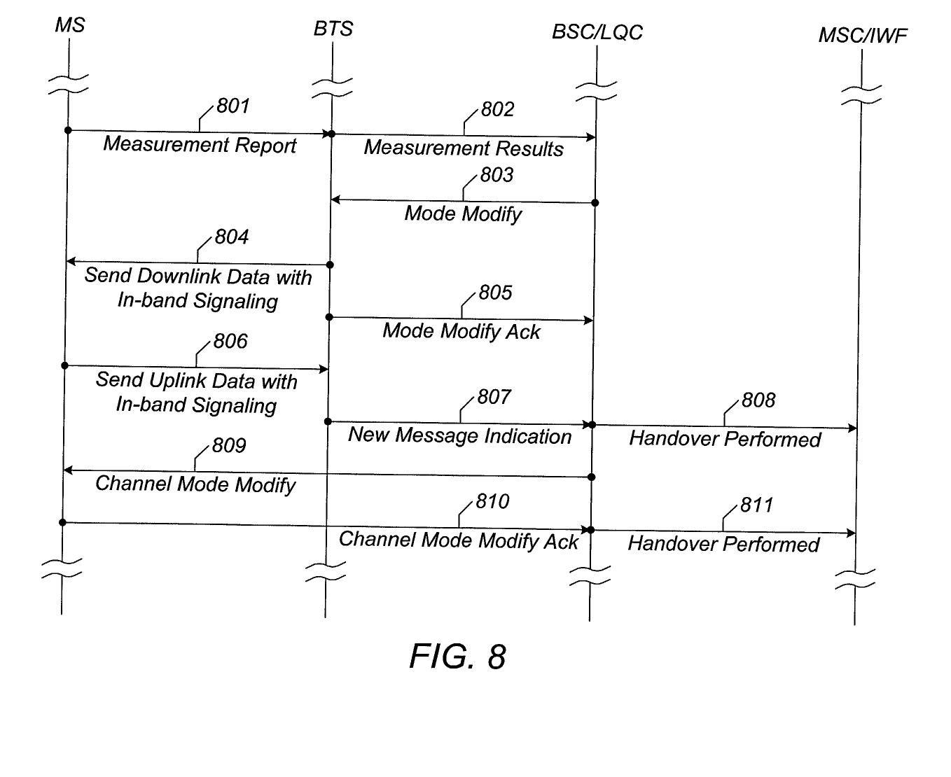

FIG. 8 illustrates yet another exemplary partial in-band signaling procedure according to some embodiments of the invention. The procedure shown in FIG. 8 differs from the procedure shown in FIG. 7 in that the two out-band signals, Channel Mode Modify and Channel Mode Modify Ack, are included at 809 and 810, respectively. This procedure provides additional security in that both the MS and the other nodes in the network are aware of the channel coding scheme change.

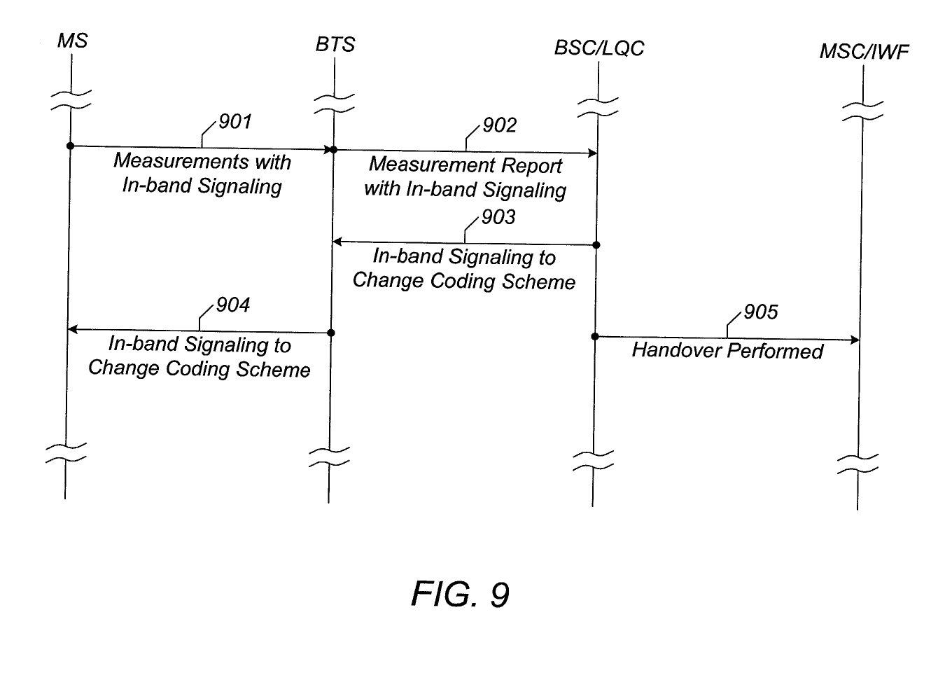

FIG. 9 illustrates an exemplary full in-band signaling procedure according to some embodiments of the invention. In this procedure, the modulation and coding scheme used as well as measurement results are all signaled in-band in both the uplink and downlink. Accordingly, at 901, the MS sends the modulation and coding scheme employed via in-band signaling on the uplink that is used to send radio quality measurements to the BTS. At 902, the uplink modulation and coding scheme is forwarded to the BSC/LQC along with the measurement results. At 903, the BSC/LQC changes its modulation and coding scheme as needed based on the measurement results and sends a message to the BTS with the new modulation and coding scheme accordingly. At 904, the BTS indicates via in-band signaling on the downlink to the MS the new modulation and coding scheme to be used. The BSC/LQC thereafter sends a Handover Performed message to the MSC/IWF at 905 to change the number of substreams in accordance with the new modulation and coding scheme.

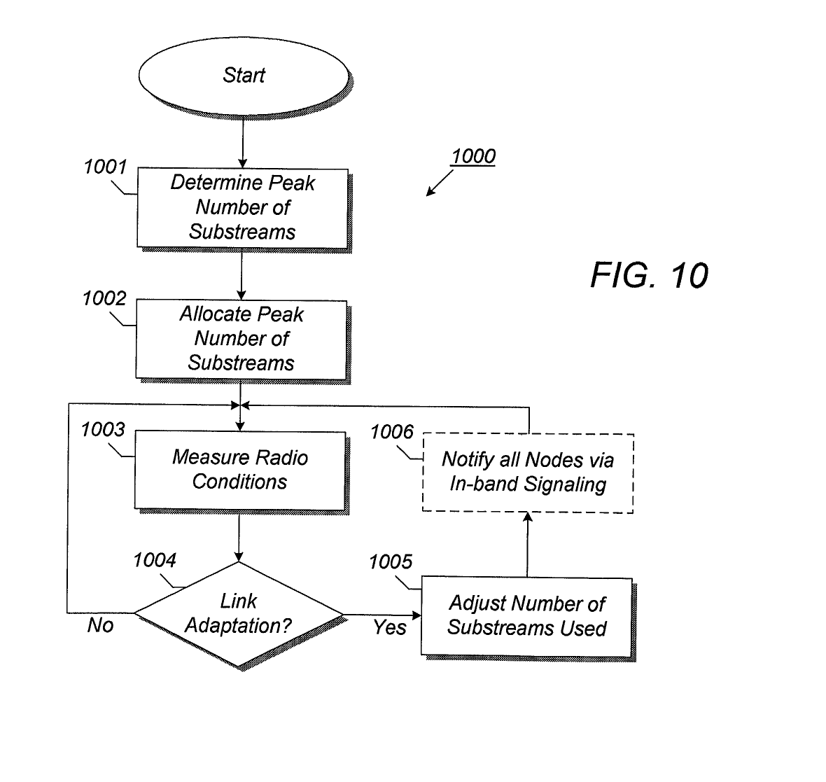

FIG. 10 illustrates a method 1000 of optimizing the data throughput in a circuit switched mobile radio connection according to some embodiments of the invention. The method includes determining a peak number of substreams that may be used for the mobile radio connection at step 1001. The peak number of substreams may be determined based on the requested user data rate and/or the number of radio frequency timeslots available to be used. At step 1002, the peak number of substreams is allocated to be used for the mobile radio connection. This allocation may be made based on a per radio frequency timeslots basis, or on a per connection basis. The radio interface is monitored at step 1003, and a determination is made at step 1004 as to whether the quality thereof is below a certain predefined level. If no, then monitoring of the radio interface continues at step 1003. If yes, the mobile radio connection is adjusted at step 1005 to use fewer substreams than the peak number of substreams. The total number of substreams allocated, however, is retained for the duration of the connection. At step 1006, the reallocation of substreams is optionally (shown as dashed lines) communicated to the other nodes in the network via in-band signaling according to some embodiments of the invention.

As demonstrated by the foregoing, embodiments of the invention provide a system and method of changing the modulation, coding scheme, and number of radio frequency timeslots in a mobile radio connection. Advantages of the invention include the reduction or elimination of interruption times and loss data associated with such changes. This arrangement allows for more frequent modulation and coding scheme adjustments, which can result in better utilization of the radio frequency resource and higher throughput for the mobile radio connection. The invention is applicable to both transparent and non-transparent services. For transparent service, a standard TSA procedure is needed to change the number of assigned timeslots. Additional advantages of the invention include less processing in the MSC/IWF and in the BSS. Furthermore, no out-band signaling is required in some embodiments, thus avoiding any mismatch in the modulation and coding scheme used on the uplink and downlink.

While a limited number of embodiments have been disclosed herein, those of ordinary skill in the art will recognize that variations and modifications from the described embodiments may be derived without departing from the scope of the invention. All numerical values disclosed herein are approximate values only regardless of whether they term “approximate” was used in describing the values. Accordingly, the appended claims are intended to cover all such variations and modifications as falling within the scope of the invention.

What is claimed is:

1. A method of optimizing data throughput in a circuit switched mobile radio connection, said method comprising:
determining a peak number of substreams to be used for data in said mobile radio connection;
allocating said peak number of substreams to be used for data in said mobile radio connection;
monitoring a quality of a radio interface;
adjusting said mobile radio connection to use fewer substreams of data than said peak number of substreams if said quality of said radio interface is below a predefined level; and
retaining any allocated substreams that have become unused for a duration of the connection.

2. The method according to claim 1, wherein said peak number of substreams are allocated on a per radio frequency timeslots basis.

3. The method according to claim 1, wherein said peak number of substreams are allocated on a per connection basis.

4. The method according to claim 1, wherein said peak number of substreams is determined based on a number of timeslots allotted to said mobile radio connection.

5. The method according to claim 4, wherein said peak number of substreams is determined based on a user requested data rate for said mobile radio connection.

6. The method according to claim 1, wherein adjusting said mobile radio connection includes changing a coding scheme thereof.

7. The method according to claim 6, wherein said coding scheme is changed via in-band signaling.

8. The method according to claim 6, wherein said coding scheme is changed via a combination of in-band and out-band signaling.

9. The method according to claim 7, further comprising sending quality measurements of said radio interface via in-band signaling.

10. The method according to claim 1, wherein adjusting said mobile radio connection includes changing a modulation scheme thereof.

11. The method according to claim 1, wherein adjusting said mobile radio connection includes changing an allotted number of radio frequency timeslots thereof.

12. A mobile communication system capable of supporting a circuit switched mobile radio connection, comprising:
a base transceiver station;
a mobile services switching center; and
a base station controller connected to said base transceiver station and said mobile services switching center, said base station controller configured to:
determine a peak number of substreams that may be used for data in said mobile radio connection;
allocate said peak number of substreams to be used for data in said mobile radio connection;
monitor a quality of a radio interface;
adjust said mobile radio connection to use fewer substreams of data than said peak number of substreams if said quality of said radio interface is below a predefined level; and
retaining any allocated substreams that have become unused for a duration of the connection.

13. The system according to claim 12, wherein said peak number of substreams are allocated on a per radio frequency timeslots basis.

14. The system according to claim 12, wherein said peak number of substreams are allocated on a per connection basis.

15. The system according to claim 12, wherein said peak number of substreams is determined based on a number of timeslots allotted to said mobile radio connection.

16. The system according to claim 15, wherein said peak number of substreams is determined based on a user requested data rate for said mobile radio connection.

17. The system according to claim 12, wherein said mobile radio connection is adjusted by changing a coding scheme thereof.

18. The system according to claim 17, wherein said coding scheme is changed via in-band signaling.

19. The system according to claim 17, wherein said coding scheme is changed via a combination of in-band and out-band signaling.

20. The system according to claim 18, further comprising sending quality measurements of said radio interface via in-band signaling.

21. The system according to claim 12, wherein said mobile radio connection is adjusted by changing a modulation scheme thereof.

22. The system according to claim 11, wherein said mobile radio connection is adjusted by changing an allotted number of radio frequency timeslots thereof.

23. A method of signaling a change in an Enhance Circuit Switched Data mobile radio connection, comprising the steps of:
using a standard signaling procedure to signal said change;
sending information regarding said change on one or more downlink traffic channels in said standard signaling procedure; and
delaying issuance of a handover signal in said standard signaling procedure until after reception of said change has been acknowledged.

24. The method according to claim 23, wherein said standard signaling procedure includes a Channel Mode Modify procedure.

25. The method according to claim 23, further comprising sending radio quality measurements reports on said one or more downlink traffic channels in said standard signaling procedure.

26. The method according to claim 23, further comprising sending information regarding said change on one or more uplink traffic channels in said standard signaling procedure.

27. An Enhance Circuit Switched Data mobile radio system, comprising:
a base transceiver station;
a mobile services switching center; and
a base station controller connected to said base transceiver station and said mobile services switching center, said base station controller configured to:
use a standard signaling procedure to signal a change in a mobile radio connection;
send information regarding said change on one or more downlink traffic channels in said standard signaling procedure; and
delay issuance of a handover signal in said standard signaling procedure until after reception of said change has been acknowledged.

28. The system according to claim 27, wherein said standard signaling procedure includes a Channel Mode Modify procedure.

29. The system according to claim 27, wherein said base station controller is further configured to send radio quality measurements reports on said one or more downlink traffic channels in said standard signaling procedure.

30. The system according to claim 27, wherein said base station controller is further configured to send information regarding said change on one or more uplink traffic channels in said standard signaling procedure.
